(19) United States
(12) Patent Application Publication
(10) Pub. No.: US 2008/0008194 A1
(43) Pub. Date: Jan. 10, 2008

(54) Device, system and method for bypassing application specific data traffic past network routing devices

(75) Inventors: Glen P. Goffin, Dublin, PA (US); Evan A. Groat, Lansdale, PA (US); David Grubb, Doylestown, PA (US); Jeffrey D. Ollis, Dresher, PA (US)

Correspondence Address: Motorola, Inc.;Law Department, 1303 East Algonquin Road, 3rd Floor, Schaumburg, IL, 60196, US

(73) Assignee: General Instrument Corporation

(21) Appl. No.: 11/482,405

(22) Filed: Jul. 7, 2006

(51) Int. Cl. H04L 12/56

(52) U.S. Cl. 370/401; 370/389

(57) ABSTRACT

A system (30) and network bypass device (28) for bypassing application specific data traffic past a network routing device. The network routing device routes data traffic between a first network, such as the Internet or wide-area network (WAN) and a second network, such as a residential network or other local area network (LAN). The network bypass device routes data traffic associated with various standard application devices in the LAN from the first network to the network routing device, for routing to the standard application devices. The network bypass device also routes data traffic associated with various application specific or bypass application devices from the first network to the bypass application devices in such a way that the data traffic bypasses the network routing device. In this manner, the flow of data traffic intended for the bypass application devices is not restricted by the network routing device and its security elements.

### BACKGROUND OF THE INVENTION

1. Field of the Invention

The invention relates to routing network data traffic. More particularly, the invention relates to routing select application data traffic past network security gateway routing devices and data traffic-limiting routing functions contained therein.

2. Description of the Related Art

Residential or home networks and other private networks often include one or more network routing or gateway devices that connect the network to the Internet and/or other public networks. The routers and gateway devices typically include firewall-type security elements at the boundary of the private network, such as the broadband point-of-access into the network, or other locations along the network. The routers and gateway devices also can include non-security network routing limitations, e.g., routing limitations that result from network routing functions like Network Address Translation (NAT) and application level gateways (ALGs), and from protocol limitations. Such security elements, which can be in the form of hardware devices, software programs or some combination of both, protect the network from unauthorized access and unwanted data traffic directed to the network, such as viruses and other corrupt data traffic. Although these security elements are useful in filtering data traffic, many of these security elements and their filtering processes intentionally and sometimes unreasonably restrict the flow of data traffic coming into and out of the network.

Many application specific services and devices, such as gaming applications, voice-over-Internet-protocol (VoIP) phones and video-over-IP phones, involve real-time applications that often would be unnecessarily impeded by network routing device security elements to the point where the quality of the application suffers. Thus, the addition of such application specific devices to a conventional residential network or other private network requires that the devices and their applications be subject to the data traffic flow restrictions of existing gateway, firewall and other security devices and elements. Moreover, the device may be subject to complete data blockage if all or a portion of the data traffic is lost or routed incorrectly. Also, partial data blockage, e.g., data packet loss, jitter, or delay, and data traffic corruption, e.g., data mangling, is possible.

Conventionally, application devices like gaming devices or IP video phones often are figuratively placed in a logical “De-Militarized Zone” (DMZ) of the network routing device to overcome data traffic flow restrictions. The DMZ is a virtual neutral zone in the network routing device between the residential network and its connection to the public network, e.g., the Internet or other networks external to the residential network. However, the placement of these application specific devices in such areas of the network routing devices usually requires the homeowner or network end user to reconfigure their network routing device properly, and such reconfiguration often is relatively complex for homeowners or network end users to understand and implement. Moreover, placing such application specific devices in the router's DMZ reduces the number of other devices that can figuratively reside therein.

### BRIEF DESCRIPTION OF THE DRAWINGS

FIG. 1 is a block diagram of a conventional system for routing data traffic between a first network, such as a wide area network (WAN) and a second network, such as a local area network (LAN);

FIG. 2 is a block diagram of a system for routing application specific data traffic, from a first network to a second network, past network routing devices;

FIG. 3 is a block diagram of a bypass device for use in a system for routing application specific data traffic past network routing devices; and

FIG. 4 is a block diagram of another system for routing application specific data traffic from a first network to a second network using a bypass network routing device.

### DETAILED DESCRIPTION

In the following description, like reference numerals indicate like components to enhance the understanding of the graphics scaling method and apparatus through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

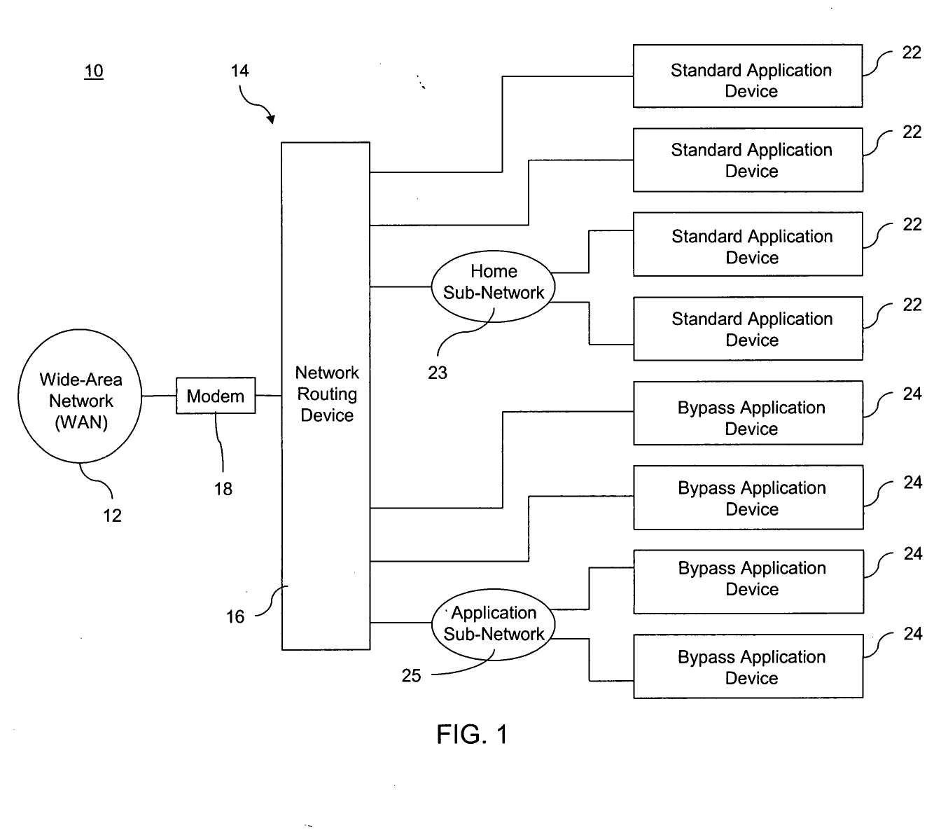

Referring now to FIG. 1, shown is a block diagram of a conventional system 10 for routing data traffic between a first network and a second network. The first network can be a wide area network (WAN) 12, such as the Internet or other suitable public network. The second network can be a local area network (LAN) 14, such as a home or residential network or other suitable private network.

The flow of data traffic between the first network 12 and the second network 14 typically occurs through a network routing device or gateway device 16, which is coupled directly or indirectly between the first and second networks. In general, the network routing device 16 allows a residential or local area network to connect to the Internet or other public networks. As discussed previously herein, the network routing device 16 typically includes at least one firewall security element or other security element that protects the residential network from unauthorized access and unwanted data traffic from external networks, or includes one or more routing functions (e.g., NAT or ALG functions) that modify or otherwise impose limitations on application data traffic.

The network routing device 16 can be a router, a residential gateway device or other suitable network routing device. A residential gateway device typically includes both a routing device and a modem, which is used to connect to the Internet or other public network. A router typically does not include a modem. Accordingly, if the network routing device 16 is a router, a modem 18 may be coupled between the first network and the router.

The residential network or LAN 14 typically includes a plurality of standard application devices 22 coupled to the network routing device 16. The standard application devices 22 typically include home computers and computer accessory devices, such as printers, facsimile (fax) machines, and other suitable application devices. One or more of the standard application devices 22 can be coupled directly to the network routing device 16. Alternatively, one or more of the standard application devices 22 can be coupled indirectly to the network routing device 16, e.g., via a home sub-network arrangement 23. The home sub-network arrangement 23 can be a router or other sub-network component coupled between the network routing device 16 and one or more standard application devices 22.

Also, the residential network or LAN 14 can include application specific devices or bypass application devices 24. Bypass application devices 24 can include gaming devices, voice-over-Internet-protocol (VoIP) devices, such as VoIP phones, video-over-Internet-protocol devices, such as video phones, and other suitable bypass application devices. As with the standard application devices 22, one or more of the bypass application devices 24 can be coupled directly to the network routing device 16 or, alternatively, can be coupled indirectly to the network routing device 16, e.g., via an application sub-network arrangement 25. The application sub-network arrangement 25 can be a router or other sub-network component coupled to one or more bypass application devices 24.

For purposes of discussion herein, the bypass application devices 24 are devices that receive data traffic that has bypassed a firewall or other security elements, such as those security elements typically located within the network routing device 16. As discussed previously herein, many of the applications of the bypass application devices 24 are real-time applications that suffer from the data traffic flow restrictions of firewall and other security elements. Yet, as can be seen from the arrangement of the conventional system 10, all data traffic between the first network 12 and the second network 14, including data traffic intended for bypass application devices 24, flows through the network routing device 16 and its firewall security elements.

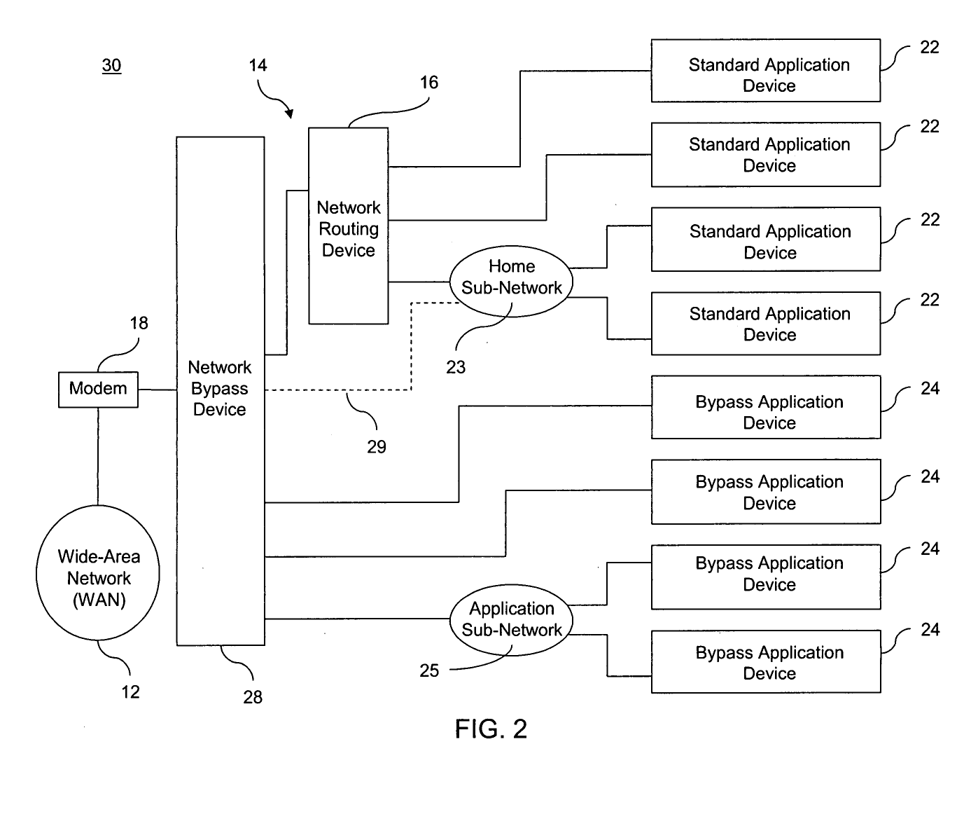

Referring now to FIG. 2, shown is a block diagram of a system 30 for routing application specific data traffic, from a first network to a second network, past a network routing device. As with the conventional system 10 shown in FIG. 1, in the system 30 shown in FIG. 2, the first network 12 can be a WAN, such as the Internet or other suitable public network, and the second network 14 can be a LAN, such as a residential network or other suitable private network.

The LAN 14 includes a plurality of standard application devices 22 coupled directly to the network routing device 16 or, alternatively, coupled indirectly to the network routing device 16, e.g., via a home sub-network arrangement 23. The LAN 14 also includes a plurality of application specific devices or bypass application devices 24, such as VoIP phones and other devices. The bypass application devices 24 may or may not be coupled to or an application sub-network arrangement 25.

Unlike the conventional system 10 shown in FIG. 1, the system 30 in FIG. 2 includes a bypass device or network bypass device 28 coupled directly or indirectly between the WAN 12 and the network routing device 16 and between the WAN 12 and at least a portion of the LAN 14 that includes one or more of the bypass application devices 24. As shown, the network bypass device 28 can be coupled directly to one or more bypass application devices 24 or indirectly via the application sub-network arrangement 25. The network bypass device 28 also is directly coupled to the network routing device 16, although the network bypass device 28 can be coupled thereto indirectly via any suitable component. Also, the network bypass device 28 can have a bridging or other suitable connection or coupling 29 to the home network 23. The network bypass device 28 is coupled directly to the WAN 12. Alternatively, if the network routing device 16 does not include a modem, the system 30 includes a modem coupled between the WAN 12 and the network bypass device 28.

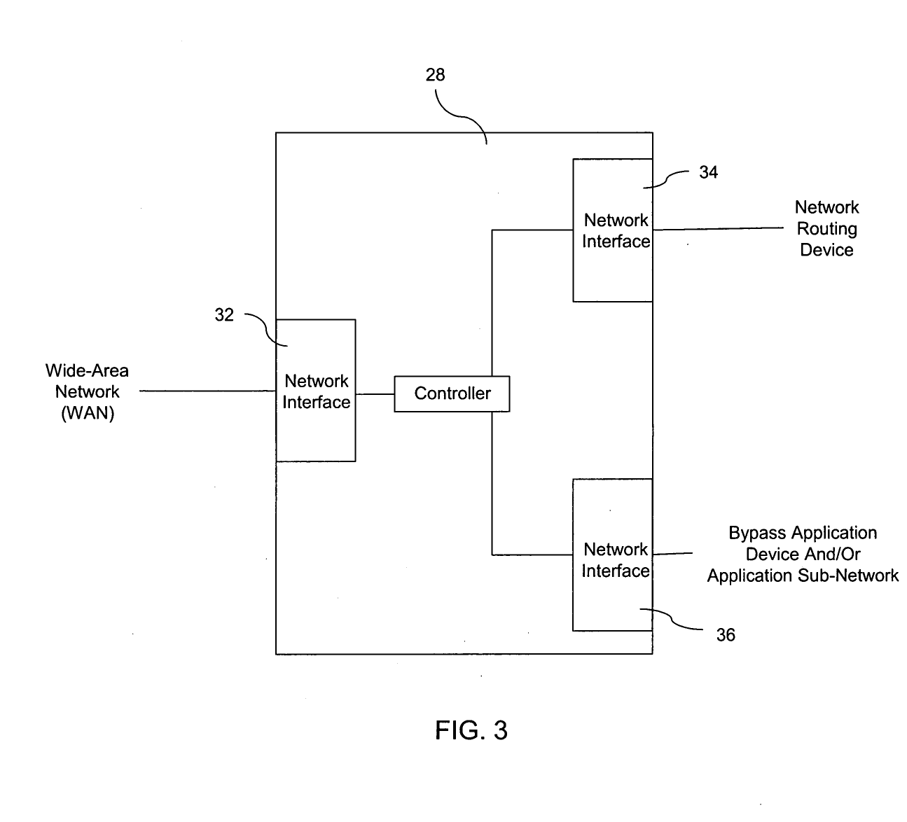

Referring now to FIG. 3, with continuing reference to FIG. 2, shown is a block diagram of the network bypass device 28 used in a system for routing application specific data traffic past a network routing device, e.g., the system 30 shown in FIG. 2. The network bypass device 28 includes a first interface or network interface 32 for coupling directly or indirectly to the first network or WAN 12, at least one second interface or network interface 34 for coupling directly or indirectly to one or more standard application devices 22, e.g., via the network routing device 16 and/or the home sub-network arrangement 23, and at least one third interface or network interface 36 for coupling directly or indirectly to one or more bypass application devices 24. The network bypass device 28 also includes a controller 38 coupled between the first network interface 32 and the second and third network interfaces 34, 36.

One or more of the first network interface 32, the controller 38, the second network interface 34 and the third network interface 36 can be comprised partially or completely of any suitable structure or arrangement, e.g., one or more integrated circuits. Also, it should be understood that the network bypass device 28 includes other components, hardware and software (not shown) that are used for the operation of other features and functions of the network bypass device 28 not specifically described herein. Such features and functions include, e.g., various application functions, addressing and traffic management functions, and general management functions.

The network bypass device 28 can be partially or completely configured in the form of hardware circuitry and/or other hardware components within a larger device or group of components. Alternatively, the network bypass device 28 can be partially or completely configured in the form of software, e.g., as processing instructions and/or one or more sets of logic or computer code. In such configuration, the logic or processing instructions typically are stored in a data storage device (not shown). The data storage device typically is coupled to a processor or controller, e.g., the controller 38 or other suitable processor or controller (not shown). The processor or controller accesses the necessary instructions from the data storage device and executes the instructions or transfers the instructions to the appropriate location within the network bypass device 28.

In operation, the network bypass device 28 receives data traffic from the WAN 12, either directly or indirectly, via one or more Ethernet connections or other suitable connections. The network bypass device 28 routes data traffic associated with or intended for one or more bypass application devices 24 to the appropriate one or more bypass application devices 24. If one or more of the intended bypass application devices 24 is coupled indirectly to the network bypass device 28 via the application sub-network arrangement 25, the network bypass device 28 routes the data traffic to the application sub-network arrangement 25. The application sub-network arrangement 25 routes the data traffic to the appropriate one or more bypass application devices 24. The network bypass device 28 also routes data traffic associated with or intended for one or more standard application devices 22 to the network routing device 16. The network routing device 16 routes the data traffic associated with one or more of the standard application devices 22 to the appropriate one or more standard application devices 22 and/or the home sub-network arrangement 23.

One or more of the connections within the LAN 14 can be any suitable home network connection. Such connections include, e.g., a token ring, Ethernet, Fast Ethernet, Gigabit Ethernet, any networking connection technology in accordance with the standards established by the HomePlug Alliance, the Home Phoneline Networking Alliance (HomePNA or HPNA) or the Multimedia over Coax Alliance (MoCA), the Standard 568 category 1 through 5 according to the American National Standards Institute/Electronic Industries Association (ANSI/EIA), powerline networking, and any networking connection technology in accordance with the IEEE 802.11 standard established by the Institute of Electrical and Electronics Engineers. Also, the LAN 14 can be partially or completely a wired network using Ethernet cables, coaxial cables, fiber optic cables, or a wireless network or any combination thereof, or other suitable coupling media. Also, all or a portion of the home network connections can support any number of suitable transmission protocols, including Transmission Control Protocol/Internet Protocol (TCP/IP).

Within the network bypass device 28, the controller 38 includes appropriate routing and switching capabilities to route data traffic received by the network bypass device 28 from the WAN 12 to its associated application devices. That is, for data traffic that is associated with or otherwise intended to be received by one or more standard application devices 22, the controller 38 routes such data traffic to one or more of the at least one second network interface 34. As discussed hereinabove, the at least one second network interface 34 is coupled directly or indirectly to one or more standard application devices 22, e.g., via the network routing device 16 and/or a home sub-network arrangement 23.

Similarly, for data traffic that is associated with or otherwise intended to be received by one or more bypass application devices 24, the controller 38 routes such data traffic to one or more of the at least one third network interface 36. As discussed above, the at least one third network interface 36 is coupled directly or indirectly to one or more bypass application devices 24 and/or application sub-network arrangement 25.

In this manner, data traffic associated with the bypass application devices 24 does not have to be routed through the network routing device 16 and its inherent firewall and/or other security elements. Thus, bypassing the network routing device 16 and its security elements allows the flow of such data traffic to be unrestricted between the WAN 12 and the bypass application devices 24. Such unrestricted data flow is advantageous for the many real-time applications of the bypass application devices 24.

Although the network bypass device 28 is shown as a separate device coupled between the WAN 12 and the network routing device 16, other suitable system configurations and arrangements are possible. For example, the network bypass device 28 can be partially or completely incorporated into the network routing device 16, e.g., as a sub-network or bypass portion within the network routing device 16.

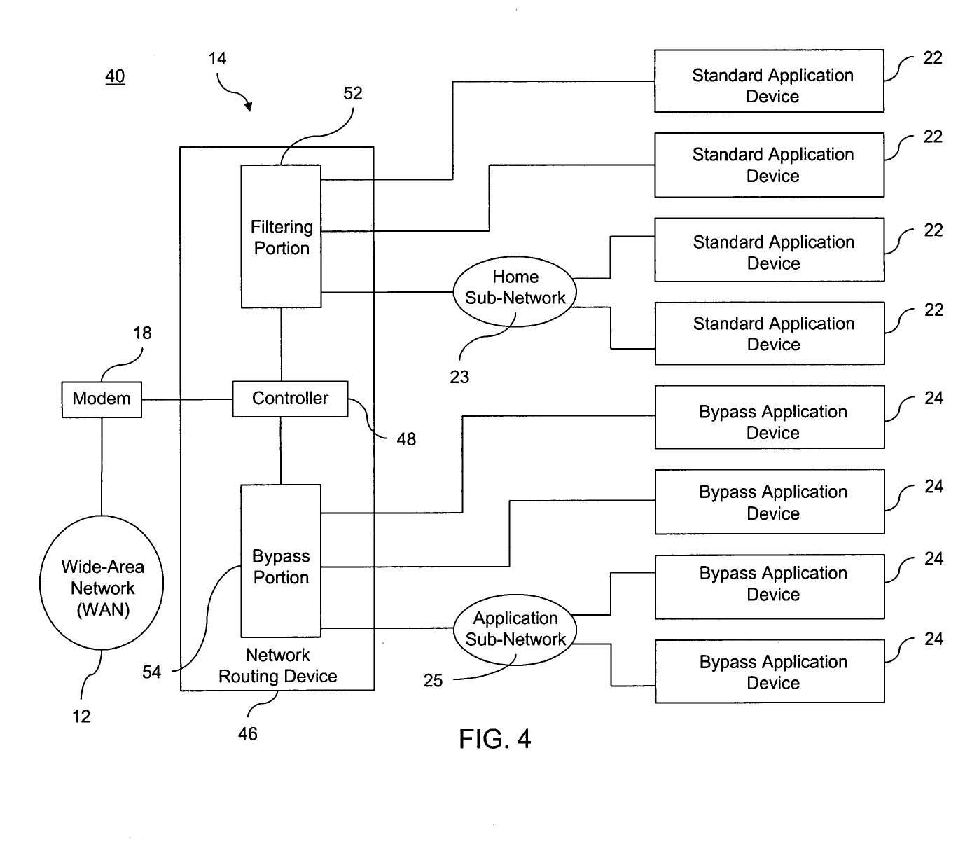

Referring now to FIG. 4, shown is a block diagram of another system 40 for routing application specific data traffic from a first network to a second network using a bypass network routing device. The system 40 includes a network routing device 46 for routing data traffic between the first network (WAN) 12 and the second network (LAN) 14. As discussed hereinabove, the LAN 14 can include one or more standard application devices 22 and one or more bypass application devices 24.

The network routing device 46 includes a controller 48 for directing the data traffic received by the network routing device 46, e.g., from the WAN 12, to the appropriate portion of the network routing device 46. The network routing device 46 also includes a filtering portion 52 for routing data traffic associated with or intended for one or more standard application devices 22 to the appropriate standard application devices 22. The filtering portion 52 typically includes the firewall and/or other security elements for filtering the data traffic to protect the standard application devices 22 from unwanted data traffic. As discussed previously herein, the portion of the network routing device that includes the security elements often restricts the flow of data traffic therethrough while filtering the data traffic. As shown, the filtering portion 52 can be coupled directly to one or more standard application devices 22 or indirectly via the home sub-network arrangement 23.

Unlike the network routing device 16 in the systems previously described herein, the network routing device 46 in the system 40 also includes a bypass portion 54 for routing data traffic associated with or intended for one or more bypass application devices 24. The bypass portion 54 represents the incorporation of a network bypass device, such as the network bypass device 28 discussed previously herein, into the network routing device 46. Thus, the bypass portion 54 typically includes at least a portion of the features and functionality of the network bypass device 28 discussed previously herein. The bypass portion can occupy an unfiltered portion or sub-network within the network routing device 46.

Data traffic associated with or otherwise intended for one or more bypass application devices 24 that is received by the network routing device 46 is directed by the controller 48 to the bypass portion 54. Accordingly, the controller 48 includes appropriate routing and switching capabilities to direct data traffic associated with or intended for one or more bypass application devices 24 to the bypass portion 54. Unlike the filtering portion 52, the bypass portion 54 does not include any elements, such as security elements, that restrict the flow of data traffic therethrough. Therefore, the flow of data traffic between the first network (WAN) 12 and one or more of the bypass application devices 24 is not affected by the bypass portion 54 in the manner that it would be if the data traffic was directed through the filtering portion 52. As shown, the bypass portion 54 can be coupled directly to one or more bypass application devices 24, or the bypass portion 54 can be coupled indirectly to one or more bypass application devices 24 via the application sub-network arrangement 25.

Instead of being incorporated into the network routing device, the network bypass device can be an add-on accessory to the network routing device network routing device. For example, the network bypass device can be a “break-out box” inserted into the physical DMZ of the home network. Alternatively, the network bypass device can be an add-on accessory to any one or more of the bypass application devices. Typically, the network bypass device is configured in such a way that the homeowner or LAN end user does not have to reconfigure the network routing device or any bypass application device. Alternatively, the network bypass device can be configured in such a way that any reconfiguration of the network routing device and/or any bypass application device is performed automatically or remotely, i.e., without input or assistance from the end user.

Other network system arrangements and configurations can include the network bypass device. For example, a network system can include a VoIP multimedia terminal adapter (MTA) as part of the network routing device. The VoIP MTA can be coupled to a VoIP telephone, e.g., via a Public Switched Telephone Network (PSTN) line. In this arrangement, the network bypass device can route or direct data traffic associated with or intended for the VoIP to the VoIP MTA in the network routing device. Also, alternatively, the VoIP MTA can be coupled between the first network (WAN) and the network bypass device. That is, the network bypass device can be coupled between the VoIP MTA and the network routing device. In this arrangement, data traffic associated with the VoIP telephone is routed directly to the VoIP telephone via the VoIP MTA. In this manner, the data traffic bypasses both the network bypass device and the network routing device.

The data traffic routing system, device and method described herein may be implemented in a general, multi-purpose or single purpose processor. Such a processor will execute instructions, either at the assembly, compiled or machine-level, to perform that process. Those instructions can be written by one of ordinary skill in the art following the description of the data traffic routing method described herein and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the device, system and method for bypassing application specific data traffic past a network routing device herein described without departing from the spirit and scope of the invention as defined by the appended claims and their full scope of equivalents.

1. A network bypass device for use in routing data traffic between a first network and a second network, wherein the second network includes at least one standard application device coupled to a network routing device and at least one bypass application device, the network bypass device comprising:
a first interface for coupling to the first network;
at least one second interface for coupling to the network routing device;
at least one third interface for coupling to the at least one bypass application device;
a controller coupled between the first interface and the second and third interfaces,
wherein the controller is configured to route data traffic associated with the at least one standard application device between the first network and the network routing device via the second interface, and wherein the controller is configured to route data traffic associated with the at least one bypass application device between the first network and the at least one bypass application device via the third interface, wherein the data traffic associated with the at least one bypass application device bypasses the network routing device.

2. The device as recited in claim 1, wherein the controller is configured to determine which data traffic is associated with the at least one standard application device and which data traffic is associated with the at least one bypass application device.

3. The device as recited in claim 1, wherein at least a portion of the controller is implemented in software executed by a computer.

4. The device as recited in claim 1, wherein at least a portion of the controller is implemented in hardware.

5. The device as recited in claim 1, wherein at least a portion of the controller further comprises an integrated circuit.

6. The device as recited in claim 1, wherein the at least one bypass application device includes a sub-network arrangement having at least one bypass application device.

7. The device as recited in claim 1, wherein the at least one standard application device includes a sub-network arrangement having at least one standard application device.

8. The device as recited in claim 1, wherein the second network includes at least one network selected from the group consisting of a local area network (LAN), a residential network, and a home network.

9. The device as recited in claim 1, wherein the first network includes at least one network selected from the group consisting of a wide area network (WAN) and the Internet.

10. A network system, comprising:
a network routing device for routing data traffic between a first network and a second network, wherein the network routing device includes at least one firewall security element that restricts the flow of data traffic therethrough; and
a network bypass device coupled between the first network and the network routing device,
wherein the second network includes at least one standard application device coupled to the network routing device and at least one bypass application device coupled to the network bypass device,
wherein the network bypass device is configured to route data traffic associated with the at least one standard application device between the first network and the network routing device, and
wherein the network bypass device is configured to route data traffic associated with the at least one bypass application device between the first network and the at least one bypass application device in such a manner that the data traffic associated with the at least one bypass application device bypasses the network routing device.

11. The system as recited in claim 10, wherein the network bypass device is configured to determine which data traffic is associated with the at least one standard application device and which data traffic is associated with the at least one bypass application device.

12. The system as recited in claim 10, wherein at least a portion of the network bypass device is contained within at least a portion of the network routing device.

13. The system as recited in claim 12, wherein the network bypass device further comprises a sub-network within the network routing device.

14. The system as recited in claim 10, wherein at least a portion of the network bypass device is implemented in software executed by a computer.

15. The system as recited in claim 10, wherein at least a portion of the network bypass device is implemented in hardware.

16. The system as recited in claim 10, wherein at least a portion of the network bypass device further comprises an integrated circuit.

17. The system as recited in claim 10, wherein the at least one bypass application device includes a sub-network arrangement having at least one bypass application device.

18. The system as recited in claim 10, wherein the at least one standard application device includes a sub-network arrangement having at least one standard application device.

19. The system as recited in claim 10, wherein the second network includes at least one network selected from the group consisting of a local area network (LAN), a residential network, and a home network.

20. The system as recited in claim 10, wherein the first network includes at least one network selected from the group consisting of a wide area network (WAN) and the Internet.

21. A computer program embodied in a computer-readable medium for routing data traffic between a first network and a second network, wherein the second network includes at least one standard application device coupled to a network routing device and at least one bypass application device, the program comprising:
instructions for receiving by a network bypass device data traffic from the first network;
instructions for routing by the network bypass device data traffic associated with the at least one standard application device between the first network and the network routing device; and
instructions for routing by the network bypass device data traffic associated with the at least one bypass application device between the first network and the at least one bypass application device in such a manner that the data traffic associated with the at least one bypass application device bypasses the network routing device.

22. The program as recited in claim 21, wherein the instructions for routing data traffic further comprise instructions for determining which data traffic is associated with the at least one standard application device and which data traffic is associated with the at least one bypass application device.
